(19) United States
(12) Patent Application Publication
(10) Pub. No.: US 2026/0245039 A1
(43) Pub. Date: Aug. 20, 2026

(54) A METHOD AND SYSTEM FOR CONSTRUCTING AND/OR OPERATING AN APPARATUS COMPRISING MULTIPLE DIFFERENT PHYSICAL COMPONENTS

(71) Applicant: KOIOS MASTER DATA LIMITED, Winchester (GB)

(72) Inventor: Peter Eales, Winchester (GB)

(21) Appl. No.: 19/162,068

(22) PCT Filed: Mar. 8, 2024
(86) PCT No.: PCT/GB2024/050636

§ 371 Date: Sep. 4, 2025

(30) Foreign Application Priority Data
Mar. 10, 2023 (GB) 2303590.0

(51) Int. Cl. G06Q 10/0875; G06Q 50/04

(52) U.S. Cl. CPC G06Q 10/0875; G06Q 50/04

(57) ABSTRACT

A system and a method are provided for constructing and/or operating an apparatus comprising multiple different physical components. The method includes maintaining a computer-implemented data store comprising at least master data records and a data dictionary. The data dictionary defines a set of concepts. Each of the master data records corresponds to a type of physical component and is associated with a concept in the data dictionary that describes that type of physical component. The method further includes curating the data dictionary by identifying first and second concepts in the data dictionary, which describe first and second types of physical component, as equivalent and combining the first and second concepts into a single concept in the data dictionary to describe both the first and second types of physical component. The method further includes determining that a physical component having the first type is to be utilised for constructing and/or operating the apparatus, and identifying in the data store a physical component of the second type, whereby the first and second types of physical components are both described by said single concept. The method further comprises utilising a physical component of the second type for constructing and/or operating the apparatus.

### FIELD

The present application relates to a method and system for constructing and/or operating an apparatus comprising multiple different physical components. The apparatus is typically a substantial engineering system compromising a large number of physical components.

### BACKGROUND

A large engineering system or machine typically has many different physical components which are interconnected and also replaceable, e.g. in response to failure of a component. Examples of such large engineering systems include factories for product manufacture; utility infrastructure such as power generation sites, water processing facilities and infrastructure; commodity production and supply such as oil rigs and refineries, mining operations; transport facilities and infrastructure, such as aeroplanes, airports, bridges, docks; large buildings with building automation systems (BAS); data processing and data communication infrastructure; complex defence systems; and so on. It will be appreciated that these examples of large engineering systems are provided by way of illustration but without limitation.

The operation, control, and management of a large engineering system is a complex task generally performed by some form of organisation, typically commercial or governmental (rather than an individual consumer). An important element of this operation (including control and management) arises from the deterioration of physical components. These may be subject to slow degradation, such as mechanical wear and tear and/or environmental corrosion, which in some cases can lead to a sudden failure, for example if the slow degradation reaches a critical threshold. A fault or failure may also occur if there is a flaw in the design, manufacture, installation and/or use of one or more physical components, or in adverse environmental conditions such as heavy flooding. In some circumstances, such a fault or failure may occur suddenly, with little or no warning.

The operator of an engineering system may need to replace a component that has failed or become degraded. A physical component may also be replaced if the usage of that component has reached some specified duration or number of operations corresponding to the expected productive lifetime of the component. Accordingly, the replacement of a physical component may sometimes be predictable and/or planned, while at other times the replacement may be required after a sudden and unexpected failure of a component. Furthermore, in some cases the replacement of a component may be a relatively straightforward operation, e.g. a new component may be installed which is a like-for-like replacement from the supplier of the previously installed component. In other cases, the replacement of a failed component may be more complicated—e.g. because the component is no longer produced by the original supplier.

The efficient management of components can play an important role in maintaining a high level of productivity from a large engineering system. Many organisations hold a large stock of various components as spare parts which may be utilised in the event that a fault develops in the large engineering system. In other words, if a particular component fails, a backup component is already available to substitute for the failed component. In practice however, holding a large stock of diverse components may be a relatively inefficient approach, since a significant proportion of parts in the overall stock might never be needed as replacements. This is wasteful of both physical and financial resources.

Other circumstances may arise in relation to physical components of a large engineering system which can lead to difficulties in the ongoing operation of the large engineering system. For example, specific components may become unavailable for a number of reasons—e.g. a supplier or distributor may go out of business or be taken over by a third party; a product line may be discontinued, for example due to legislative changes or because it is no longer profitable; there may be delays in manufacturing a component, for example due to a shortage of raw materials and/or sub-components. Such circumstances may lead to undesired downtime or limited operational availability of a large engineering system.

There has been some recognition of the importance of data exchange to support the complexity of modern engineering systems, including their supply chains, their maintenance requirements, their interoperability with other systems, and so on. A framework of standards has been developed by the International Organization for Standardization (ISO) to support data exchange. One standard of relevance is ISO 8000-110—see https://www.iso.org/standard/78501.html, which specifies requirements for the exchange of messages that contain master data consisting of characteristic data. This standard includes the following use example:

A supplier sends a message to a customer. The message contains characteristic data describing an item that the customer is considering buying.
The following are within the scope of this document:
   conformance of master data messages to a formal syntax;
   semantic encoding of master data messages;
   conformance of master data messages to data specifications;
   requirements on access to the data dictionaries that enable decoding of master data messages.

While the ISO 8000-110 standard has a broad range of application regarding the exchange of data between organisations, in the present application we generally consider the “item” as representing a physical component in an engineering system or machine and the “characteristic data” as representing physical parameters and properties of the item. In addition, the present application considers an organisation determining whether to use a particular item as a replacement in a large engineering system. The utilisation of the ISO 8000-110 standard for such a context is supported by the classification of this standard under the International classification of standards (ICS) to ICS 25.040.40, namely “Industrial process measurement and control”.

Although ISO 8000-110 provides a helpful framework for the control and exploitation of certain data relating to components in large engineering systems, existing implementations tend to focus on collecting data, rather than the specific application of such data to support the ongoing operation and maintenance of a large engineering system.

### SUMMARY

The invention is defined in the appended claims.

As described herein, a system and a method are provided for constructing and/or operating an apparatus comprising multiple different physical components. The method includes maintaining a computer-implemented data store comprising at least master data records and a data dictionary. The data dictionary defines a set of concepts. Each of the master data records corresponds to a type of physical component and is associated with a concept in the data dictionary that describes that type of physical component. The method further includes curating the data dictionary by identifying first and second concepts in the data dictionary, which describe first and second types of physical component, as equivalent and combining the first and second concepts into a single concept in the data dictionary to describe both the first and second types of physical component. The method further includes determining that a physical component having the first type is to be utilised for constructing and/or operating the apparatus, and identifying in the data store a physical component of the second type, whereby the first and second types of physical components are both described by said single concept. The method further comprises utilising a physical component of the second type for constructing and/or operating the apparatus.

The apparatus may be a machine, large engineering system or similar.

Also as described herein, a method and a computer system are provided. The computer system includes a curated data dictionary for use in a data store comprising at least master data and the data dictionary. The data dictionary defines a set of concepts and the master data comprises a set of records, each record corresponding to a type of physical component associated with at least one concept in the data dictionary. The data dictionary is curated by identifying as equivalent first and second concepts in the data dictionary associated with first and second types of physical component, and combining the first and second concepts into a single concept in the data dictionary to describe both the first and second types of physical component.

Some implementations of the approach described herein may provide a controlled collection of data dictionary entries in which concepts are created by mapping one or more <industrial> terms and one or more definitions together by their semantic meaning to allow the user (dictionary searcher) to find and select their preferred term. Such an approach facilitates the exchange of data to be performed with little or no loss of meaning in multiple natural languages.

### BRIEF DESCRIPTION OF THE FIGURES

Various implementations of the claimed invention are now described by way of example only with reference to the following drawings.

FIG. 1 is a schematic overview of a computer-implemented data store in accordance with ISO 8000-110 which is used by way of example for the approach described herein.

FIG. 2 is an example of a data record (catalogue entry) forming part of the master data which is included in the system implementation shown in FIG. 1.

FIG. 3 is another example of a data record (catalogue entry) forming part of the master data which is included in the data store shown in FIG. 1.

FIG. 4 is an example of a data specification record which may form part of the data store shown in FIG. 1. The master data record shown in FIG. 2 conforms to the data specification record shown in FIG. 4.

FIG. 5 provides another example of part of a data specification which may be used in a data store such as shown in FIG. 1.

FIG. 6 is a schematic representation of an example of a concept in a data dictionary which may be used in a data store such as shown in FIG. 1.

FIGS. 7A and 7B are schematic diagrams illustrating two different methods for curating concepts in a data dictionary by way of example for the approach described herein.

FIG. 8 is a flowchart illustrating an example of the curation of concepts in a data dictionary as described herein.

FIG. 9 is a schematic representation of another example of a concept in a data dictionary which may be used in a data store such as shown in FIG. 1.

FIG. 10 is a schematic representation of another example of a concept in a data dictionary which may be used in a data store such as shown in FIG. 1.

FIG. 11 is a schematic, example representation of the construction of identifiers in accordance with an identification scheme for use in a data store such as shown in FIG. 1.

FIG. 12 is a schematic diagram of an example computer screen for utilising a data store such as shown in FIG. 1.

FIG. 13 is a schematic diagram of an engineering system interacting with a management system which uses a data store such as shown in FIG. 1.

FIG. 14 is a flowchart showing a method for operating an engineering system utilising a data store such as shown in FIG. 1.

FIG. 15 is a flowchart showing a method for supporting authentication of products for transportation using a data store such as shown in FIG. 1.

### DETAILED DESCRIPTION

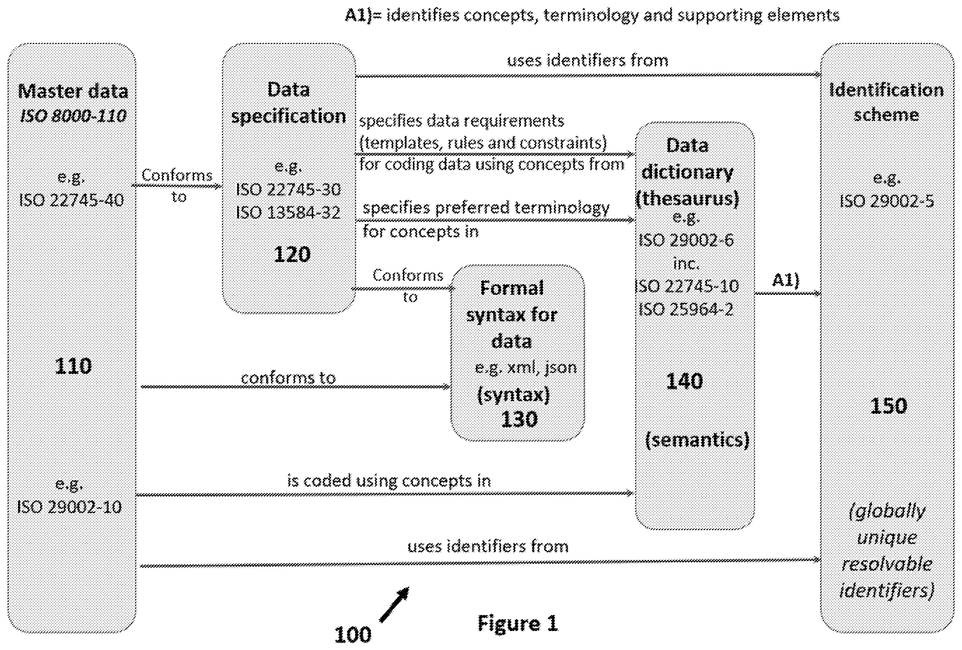

FIG. 1 is an overview of an example computer-implemented data store 100 in accordance with ISO 8000-110 for use in the approach described herein. The data store 100 may be used to provide a high-level data architecture for managing data quality and enabling the exchange of machine-readable data. Such a data store 100 may be used in the context of operating a large engineering system comprising many different physical components to assist, inter alia, in the replacement of such physical components.

The data store 100 of FIG. 1 includes five main components, namely master data 110, a data specification 120, a formal data syntax 130, a data dictionary 140, and an identification scheme 150. The high-level configuration of these components generally follows the ISO 8000-110 standard, however, the implementation of these components as described herein goes beyond these higher-level teachings of the ISO 8000-110 standard. It will be appreciated that the computer-implemented data store 100 not only provides a storage facility for saving the various components shown in FIG. 1, but also comprises functionality, for example computer programs, to interact and work with the data store 100, such as to develop, maintain, access and manipulate the data elements held within the data store 100.

To assist in the discussion, the following terms are used:
Master data—data held by an organization to describe the entities that are both independent and functional for that organization, and referenced in order to perform its translations.
Formal syntax—specifications of the valid sentences of a formal language using a formal grammar (EXAMPLE: an XML document type definition (DTD) represents a formal syntax)
Data specifications—rules for describing items belonging to a particular class using entries from a concept dictionary and reference to a specific formal syntax
Data dictionary—a collection of data dictionary entries that allows lookup by entity identifier
Identification scheme—a system for allocating identifiers to registered objects.

Note the above description of terms is intended to provide indications of typical usage, rather than formal definitions, and hence should not be regarded as limiting. For example, the master data is defined at the level of the standard to generally represent data held by an organization which is utilised in transactions and other operations performed by the organization. The present application is primarily directed at a more specific context in which the organisation uses the master data to support the operation of a machine or engineering system. In particular, data items in the master data relate to corresponding physical components for use in the machine or engineering system.

One example of this context is where the master data 110 represents a supplier catalogue containing information about physical components available from the supplier, wherein the physical components may be ordered (acquired) by a party responsible for running the large engineering system to support continued operation of the large engineering system. The supplier may, for example, be a parts manufacturer and/or a parts distributor. In another example, the master data may represent a bill of materials which provides a listing or catalogue of physical components for use in the construction of a large engineering system. In this example, the master data may be maintained by an organisation responsible for the construction or installation of the large engineering system.

The master data may be created with regard to other ISO standards such as ISO 29002-10, ISO 25964-2 and/or ISO 22745-40 (by way of example). Considering first ISO 29002-10, this relates to industrial automation systems and integration and to the exchange of characteristic data in such systems. The data exchange is based on a conceptual model using Unified Modelling Language (UML) and the physical file format is based on Extensible Markup Language (XML) as per the formal syntax 130 (which is described in more detail below). Like the ISO 8000-110 standard, the ISO 29002-10 standard is also classified to ICS 25.040.40, namely “Industrial process measurement and control”. Regarding ISO 22745-40, this is a specialisation of ISO 29002-10 that specifies a conceptual information model and an exchange file format for catalogues. Again, the conceptual information model uses Unified Modeling Language (UML) and the physical file format is specified via an Extensible Markup Language (XML) schema. The ISO 22745-40 standard is classified to ICS 25.040.01, namely “Industrial automation systems in general”.

According to the ISO 22745-40 standard, a catalogue is a collection of master data records. A master data record is made up of characteristic data expressed as property/value pairs, where the property is identified by reference to a concept in an open technical dictionary. Such an open technical dictionary may be the data dictionary 140 shown in FIG. 1.

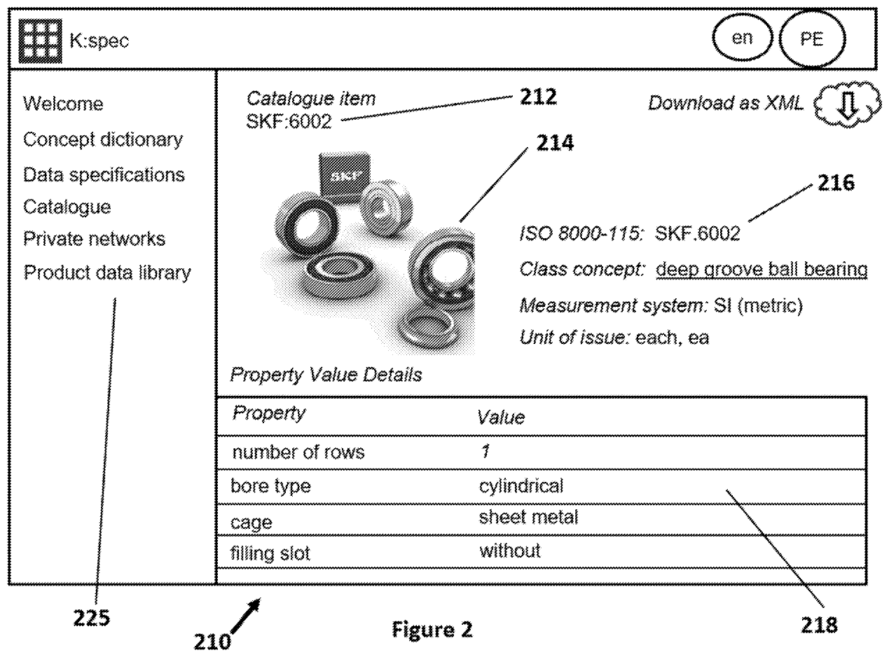

FIG. 2 is an example of a master data record 210 corresponding to a particular catalogue entry for a physical component. The master data 110 typically comprises a large number of different master data records 210 (such as might be expected in a product or parts catalogue). In the example of FIG. 2, the catalogue entry 210 corresponds to physical component which is a ball bearing, more particularly one specific type of ball bearing, namely a deep groove ball bearing. The master data record 210 is therefore one example of a catalogue entry for a given component from the set of catalogue entries held as the master data 110 shown in FIG. 1 as part of the data store 100.

The master data record 210 includes an identifier 212 of the catalogue entry for the ball bearing. This identifier is allocated by the owner/producer of the catalogue represented by the master data 110. The master data record 210 further includes an image 214 of the relevant component (the ball bearing). In addition, the master data record 210 holds information about the relevant component by way of a set of property-value pairs. In other words, the master data record identifies a set of properties associated with the component represented by the master data record 210, whereby the values provided in the master data record 210 for these properties in effect define the associated physical component.

The property-value pairs shown in FIG. 2 are split into two groups. The first group 216 can be considered as a form of header and provide values for four properties, namely an ISO 22745-40 identifier, a class concept (type of product-in this case a deep groove ball bearing), a measurement system (metric) for representing the component, and a unit of issue, which is “each” to indicate that individual ones of this physical component can be supplied (rather than only being available, for example, in a box of 10).

The second group 218 of property-value pairs provides further property-value information relating to the ball bearing. Note that FIG. 2 shows only the initial portion of this second group 218. In a typical implementation, further property/value pairs can be located and utilised by scrolling down further through the second group 218. In the example of FIG. 2, the property “cage” has the associated value “sheet metal”. The user is able to set this particular value (“sheet metal”) from a list of allowed values defined in the data specification 120 (as discussed in more detail below). The use of such lists of values to provide a limited set of predefined options for a user helps to maintain data quality and reliability by enforcing a more consistent (and correct) terminology across all users.

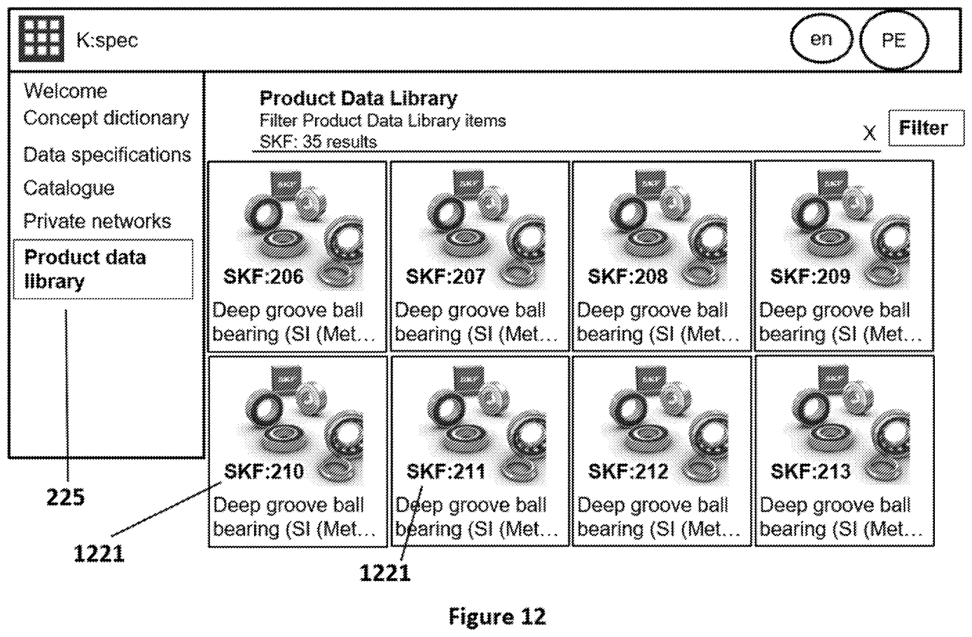

FIG. 2 further shows a side bar 225 which presents various options to a user of the data store 100 shown in FIG. 1. One option provides access to the concept dictionary 140 as described in more detail below. Another option provides access to the data specification(s) 120 as also described in more detail below. Another option provides access to the catalogue, which may be used, for example, to access manufacturer data sheets for physical components corresponding to entries in the catalogue implemented by the master data 110. A further option in the side bar 225 is to utilise certain private networks, for example if the user is accessing the data store 100 remotely over a public network such as the Internet. Another option in the side bar 225 is to access a product data library, as discussed below with reference to FIG. 12.

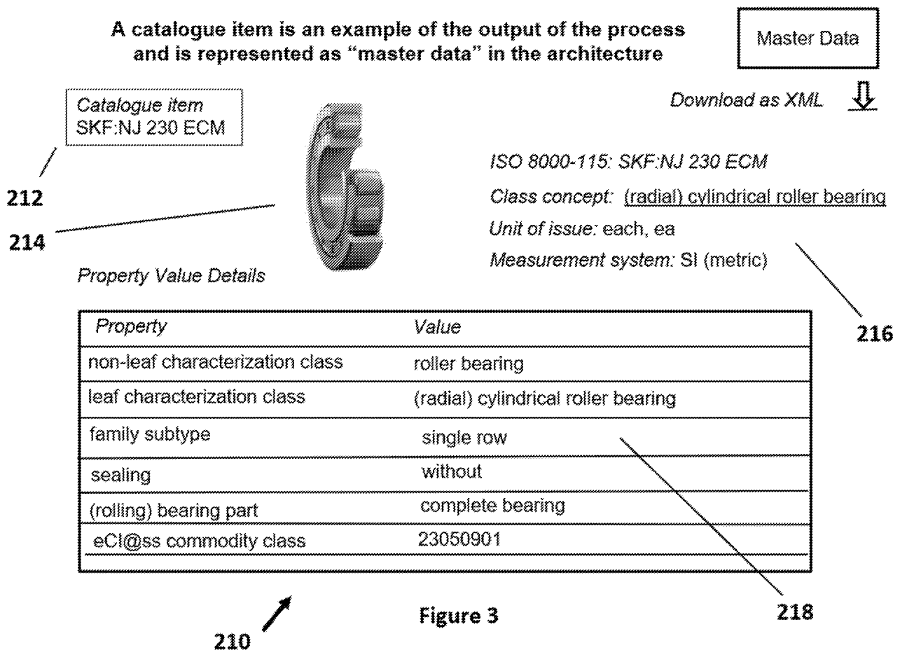

FIG. 3 is another example of a master data record (catalogue entry) 210 forming part of the master data 110 which is included in the data store 100 shown in FIG. 1. Again, the master data record 210 includes an identifier 212 of the catalogue entry, in this case a cylindrical roller bearing. This identifier may be allocated by the owner/producer of the catalogue represented by the master data 110. The master data record 210 further includes an image 214 of the cylindrical roller bearing and a set of property-value pairs associated with the component represented by the master data record 210. Again, the property-value pairs shown in FIG. 3 are split into two groups: the first group 216 in the form of header, and a second group 218 of property-value pairs to provide further property-value information relating to the roller bearing. Note that FIG. 3 shows only the initial portion of this second group 218. In a typical implementation, further property/value pairs can be located and utilised by scrolling down further through the second group 218.

In both FIGS. 2 and 3, the properties 218 are listed. This indicates that each of these properties represents a corresponding concept taken from the data dictionary 140 as described below. By way of example, the “bore type” property in FIG. 2 and the “sealing” property in FIG. 3 both correspond to a concept in the data dictionary 140. In addition, the values in FIGS. 2 and 3 are generally also listed. By way of example, the value “cylindrical” in FIG. 2, paired with the property “bore type, and the value “without” in FIG. 3, paired with the property “sealing”, likewise correspond to concepts in the data dictionary 140. Note however that the value shown in FIG. 2 corresponding to the property “number of rows” is indicated as “1” in italics. This italics here indicates that “1” does not correspond to a concept in the data dictionary (but rather adopts its conventional, numerical meaning).

The data store further includes a data specification 120 which can be considered as defining (specifying) a class of products or components. In particular, the data specification 120 provides rules for describing items belonging to a particular class using entries from a concept dictionary 140 and with reference to the specific formal syntax 130. Accordingly, the concept dictionary may be implemented by the data dictionary 140 shown in FIG. 1, while the formal syntax may be specified by system 130 shown in FIG. 1 (the data dictionary 140 and the system 130 are described in more detail below).

An entry in the master data 110 conforms to a corresponding class in the data specification 120. For example, the header 216 in FIG. 2 specifies a class concept of “deep groove ball bearing”, while the header 216 in FIG. 3 specifies a class concept of “(radial) cylindrical roller bearing”. The data specification further conforms to ISO standards ISO 22745-30 and ISO 13584-32. The ISO 22745-30 standard is related to ISO 22745-40 as described above, and specifies a conceptual information model for identification guides and data types, as well as specifying an XML exchange structure for identification guides. The ISO 22745-30 standard (like the ISO 22745-40 standard) is classified to ICS 25.040.01, namely “Industrial automation systems in general”. The ISO 13584-32 standard relates to OntoML, which is a product ontology markup language. In particular, OntoML is used to provide an XML-based exchange structure for ISO 13584 compliant data such as may be used in the formal syntax 130 of FIG. 1. The ISO 13584-32 standard is classified to ICS: 25.040.40, namely “Industrial process measurement and control”.

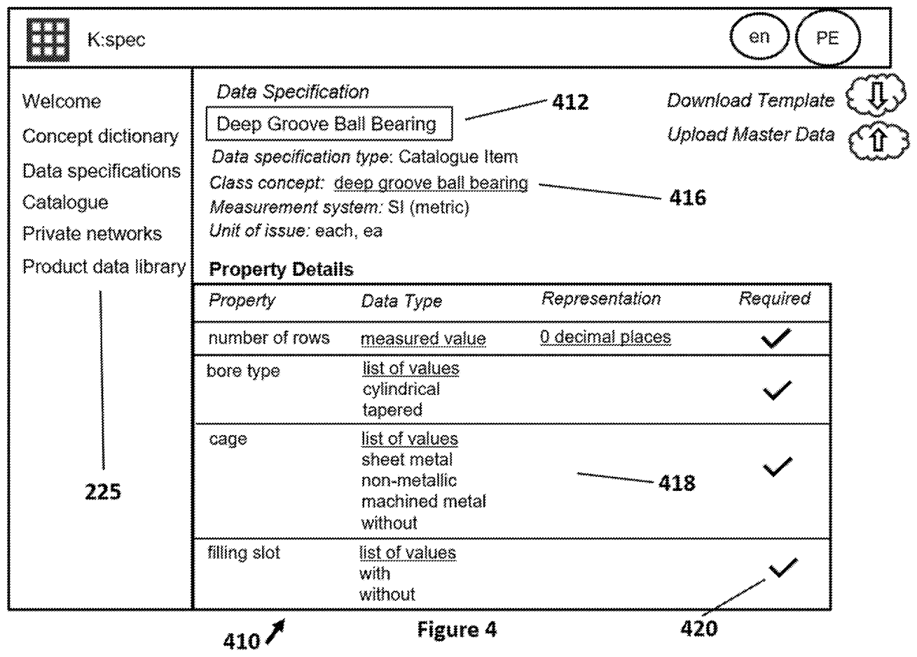

FIG. 4 is an example of a data specification record 410 which is part of the data store 100 shown in FIG. 1. In particular, the data specification 120 shown in FIG. 1 typically contains a large number of such data specification records 410. Each data specification record 410 relates to one or more master data records 210 (although the set of master data records 210 in any given data store 100 may not necessarily implement all the data specification records 410 from the data specification 120).

Each of the master data records 210 shown in FIGS. 2 and 3 conforms to a respective data specification 410. FIG. 4 represents a data specification record 410 corresponding to the master data record 210 shown in FIG. 2. In other words, the master data record 210 shown in FIG. 2 conforms to the data specification record 410 shown in FIG. 4. The data specification record 410 can be considered as providing a structure to define a class (of components), and the master data records 210 that conform to the corresponding data specification 410 may be regarded as implementations or instantiations of this class.

The data specification 410 includes a title 412, a first set of properties 416 as a form of header or key information, and a second set of properties 418. The title 412 describes the class to which this data specification relates and this is also reflected in the header 416, in which the class concept is identified as: “deep groove ball bearing”. This class concept relates to a corresponding concept in the data dictionary 140. A class is somewhat more generic than a particular catalogue identifier 212 such as shown in FIG. 2. In other words, multiple catalogue entries (identifiers) may derive from and conform to the same class concept.

This distinction explains why the master data entry 210 includes a catalogue identifier 212 as shown in FIG. 2, but no such catalogue identifier is present in the class data specification 410 shown in FIG. 4. The catalogue identifier 212 is not a physical property of a bearing, shared by all implementations. On the contrary, two different implementations of the bearing, e.g. as sold by different distributors or as made by different manufacturers, might be allocated two different (respective) catalogue identifiers. Accordingly, the catalogue identifier 212 is a property associated with a particular master data record 210, but is not a property of the generic class defined by the relevant data specification entry 410.

It can be seen that the properties 416, 418 identified for the data specification record 410 match the properties 216, 218 defined for the master data entry 210—confirming that the master data record 210 properly conforms to the corresponding data specification record 410. As for FIGS. 2 and 3, FIG. 4 only shows the initial portion of the second group of properties 418. In a typical implementation, further properties can be located and utilised by scrolling down further through the second group 418.

In FIG. 2, each master data record 210 is based on a set of property-value pairs. Although the data specification record 310 of FIG. 4 includes the same properties as the corresponding master data entry, the data specification record 410 does not have a respective value for each property. Rather, the data specification record 410 defines information about the range of acceptable values, also referred to as the domain of the value. This information may also include the format (data type) of the value. As a simple example, for the data specification record 410 shown in FIG. 4, the values are indicated as having a domain of “list of values”. In this case, when the user creates the master data catalogue entry 210 from this data specification entry, for a given property the user is presented with (e.g.) a drop-down list of possible values corresponding to this property, and selects the value from the list that is appropriate for this particular catalogue entry. In this context, the list of possible values in effect defines the domain value.

In the example of FIG. 4, most of the properties are indicated as having a “list of values” data type. As mentioned above, this approach helps to maintain consistency and data quality. The data specification record 410 also specifies the set of values that make up the list. Accordingly, the data specification record 410 can also be regarded as defining the value domain. Thus with respect to the “bore type” property, this has two possible values—“cylindrical” or “tapered”. When a user creates a master data record 210 corresponding to the data specification record 410, for each property defined as having a list of values, the user selects one of the values in this list to define a specific property-value pair for the master data record. Thus for the example shown in FIG. 2, the master data record 210 has selected the particular value of “cylindrical” for the property “bore type”.

Most of the values included in the lists of values for the data specification record 410 correspond to concepts from the data dictionary 140 as described in more detail below. In contrast, the property “number of rows” is defined as a measured value, rather than providing a list of values. This measured value is also defined in the data specification record 410 as having 0 decimal places, and hence corresponds to an integer (whole number). In the master data record 210 of FIG. 2, the property “number of rows” has the value 1, which conforms to the requirement of the data specification record 410 for this property to have a measured value.

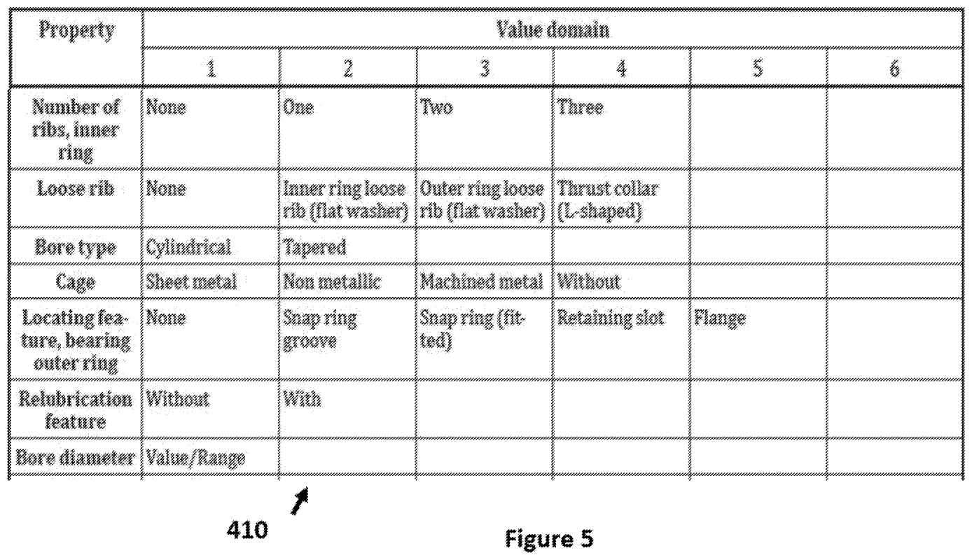

FIG. 5 provides another example of a portion of a data specification 410, which is taken from ISO 21107 directed to “Rolling Bearings and spherical plain bearings” and classified to ICS 21.100.01, namely “Bearings in general”. It will be appreciated that similar to FIG. 4 (and analogous to FIGS. 2 and 3), the data specification 410 shown in FIG. 5 is only a portion of the full data specification, which includes further properties and corresponding data types not shown in FIG. 5.

The data specification 410 in FIG. 5 is presented as a table in which each item (row) in the data specification 410 comprises a pair of (i) property, such as described above in relation to FIGS. 2 and 3, and (ii) value domain (data type), such as described above in relation to FIG. 4. The data specification of FIG. 5 includes 7 rows of properties (in addition to the headers).

The value domain is shown in FIG. 5 as comprising 6 columns. For most of the properties in the data specification 410, these six columns are used to store different values from a list of potential values. For example, in the first row, the property corresponding to the “Number of ribs” in the inner ring is defined to be 0, 1, 2 or 3 according to the user selected column. Similarly, in the third row, the property corresponding to the “bore type” is defined to be “cylindrical” or “tapered”. In contrast, for the bottom row shown in the data specification 410, the property is “bore diameter”, and the corresponding data type (value domain) is specified as Value/Range. In particular, the system designer may require that a user specifies the bore diameter as a single numerical value, such as 6.25 mm; alternatively, the system designer may require that a user specifies the bore diameter by using a numerical range defined by a lower value and an upper value, such as 6.0-6.3 mm.

Returning to FIG. 1, both the master data 110 and the data specification 120 confirm to the formal data syntax 130. This syntax is generally specified using Extensible Markup Language (XML), see for example https://en.wikipedia.org/wiki/XML, which provides a facility to allow different organisations to exchange data based upon a standardised structure, although other facilities such as json may be used in conjunction with (or replacement of) XML.

XML can be used in combination with related facilities, such as an XML Schema (XSD) which specifies how to formally describe the elements in an XML document and can be used to verify that an XML document is correctly structured, see for example https://en.wikipedia.org/wiki/XML_Schema_(W3C). XML and related technologies are well-known to the skilled person, including in the context of ISO 8000-110, and hence for conciseness will not be further described herein.

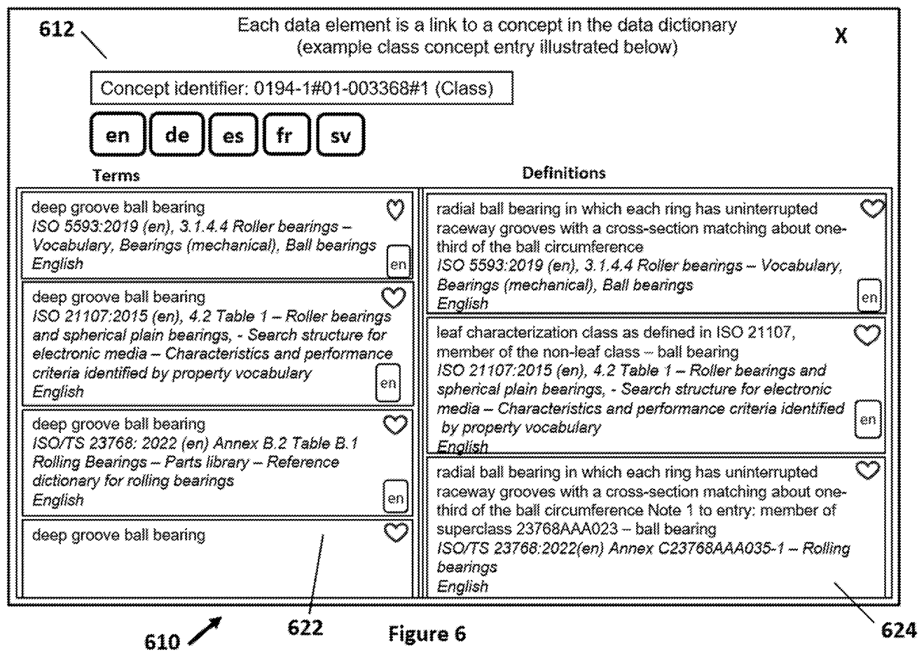

FIG. 6 is a schematic representation of an example concept from a data dictionary 140 which may be used in a data store 100 such as shown in FIG. 1. As mentioned above, each data element may be a link to a concept in the data dictionary 140 (this support, for example, by using a particular colour such as blue, for both the data element and the linked concept in the data dictionary. FIG. 6 provides an example of one such concept 610 in the data dictionary 140, and the data dictionary 140 typically contains a large number of such concepts 610 (analogous to the master data 110 containing multiple master data records 210 and the data specification 120 containing multiple data specification records 410).

The data dictionary 140 supports different types of concept 610. The concept 610 illustrated in FIG. 6 represents a class (as previously discussed in relation to the data specification 410).

There are other types of concept in the data dictionary 140, such as a property concept. Further information on these other types of concept is provided below. Significantly, the data dictionary 140 is more than just an aggregate of existing terminology, rather it is a carefully curated set of concepts in which each concept 610 in the data dictionary relates to a different type of entity—i.e. the concepts are ontologically distinct from one another.

The concept 610 shown in FIG. 6 includes an identifier or title 612, a set of terms 622, and a set of definitions 624. Note that the terms 622 and definitions 624 are not cross-linked to each other (in contrast to the property-value pairs in the master data record 210), rather they are only associated with one another in that they belong to the same concept 610. Accordingly, the terms 622 and the definitions 624 can be regarded as two separate listings, both listings belonging to the same concept 610. Note that FIG. 6 shows only a subset of these two listings—a user can scroll up and/or down the listings to access further terms and/or definitions for this concept 610 which are not currently displayed in the example shown in FIG. 6.

Each concept is assigned a unique concept identifier 612. In contrast to the identifiers 212 for the master data records 210, which may correspond to supplier reference identifiers for components included in the master data 110 and may potentially be derived from pre-existing catalogues, the unique concept identifiers 612 are generally provided by the developer and operator of the data store 100 (and in particular, by the developer/operator of the data dictionary 140). The concept identifiers 612 conform to the identification scheme 150 as shown in FIG. 1 (and as discussed in more detail below).

Note that in FIG. 1, the arrow between the data dictionary 140 and the identification scheme 150 is indicated the label A1. The functionality associated with A1 (identifies concepts, terminology, and supporting elements) is keyed at the top of FIG. 1.

Each of the terms 622 is derived from a particular source which uses that term to reference the concept 610. For example, the first entry in the terms listing 622 of FIG. 6 is for a “deep groove ball bearing” and it is specified that this term is provided by (derived from) a specific section in ISO 5593:2019. The second entry in the terms listing 622 of FIG. 6 is for “deep groove ball bearings”, i.e. a pluralised form, and this term is taken from a specific location in ISO 21107:2015. The third entry in the terms listing 622 of FIG. 6 is for “deep groove ball bearing 23768AAA035” and this term is taken from ISO/TS 23768:2022. Thus for each term 622 provided in the concept 610, a source or citation supporting the use of such term is included within the term

In analogous fashion, each of the definitions 624 corresponding to the concept 610 is likewise taken from a particular source which uses that definition to describe the concept 610. For example, the first entry in the definitions listing 624 of FIG. 6 is for a “radial ball bearing in which each ring has uninterrupted raceway grooves with a cross-section matching about one-third of the ball circumference”, which is taken from ISO 5593:2019. The second entry in the definitions listing 624 of FIG. 6 is for a “leaf characterisation class as defined in ISO 21107, member of the non-leaf class ball bearing”. These two definitions are different from one another at a textual level, but are substantially equivalent at a technical level. The same applies to the third entry in the definitions listing 624 of FIG. 6, which again has a definition that is different from the first two definitions in textual terms, but substantially equivalent in technical terms.

The data dictionary 140 is subject to a curation procedure, in which the concepts 610 in the data dictionary 140 are reviewed to identify cases in which two different concepts in the data dictionary are substantially equivalent to one another. For present purposes and by way of illustration, we focus on a subset of the concepts 610 in the data dictionary 140—namely those concepts which correspond to a class of physical components. An example of such a class concept 610 is the “deep groove ball bearing” included in the header 216 of the master data record 210 shown in FIG. 2, see also the title 412 of the data specification record 410 shown in FIG. 4.

The curation process may identify two (or more) different concepts in the data dictionary 140 as substantially identical to one another for example because they are both derived from the same entity for a given standard, or from two closely related entities. The curation may also identify two (or more) different concepts in the data dictionary 140 as substantially identical to one another if they have respective terms and/or respective definitions that do not indicate any technical distinction between the two or more concepts 610.

Once the curation process has identified two or more concepts as substantially equivalent to one another, these two or more concepts may be combined into a single concept. In some cases, the single concept may be newly created to accumulate and hold data from the two or more substantially equivalent concepts. In this approach, after the single concept has been created, the two or more substantially equivalent concepts used to form the single concept are retained in the data dictionary 140, but in deprecated form. In some cases, the data store 100 may be configured so that the deprecated concepts may be unavailable for normal user operations, but available for audit, system management, and retaining the ability to access legacy products which still use the original concepts). In other cases, a first concept within the two more substantially equivalent concepts may be amended to form the single (amalgamated) concept. In this latter situation, the first concept from the two or more equivalent concepts is retained in amended form as the single concept, but the other ones of the two or more equivalent concepts are deprecated.

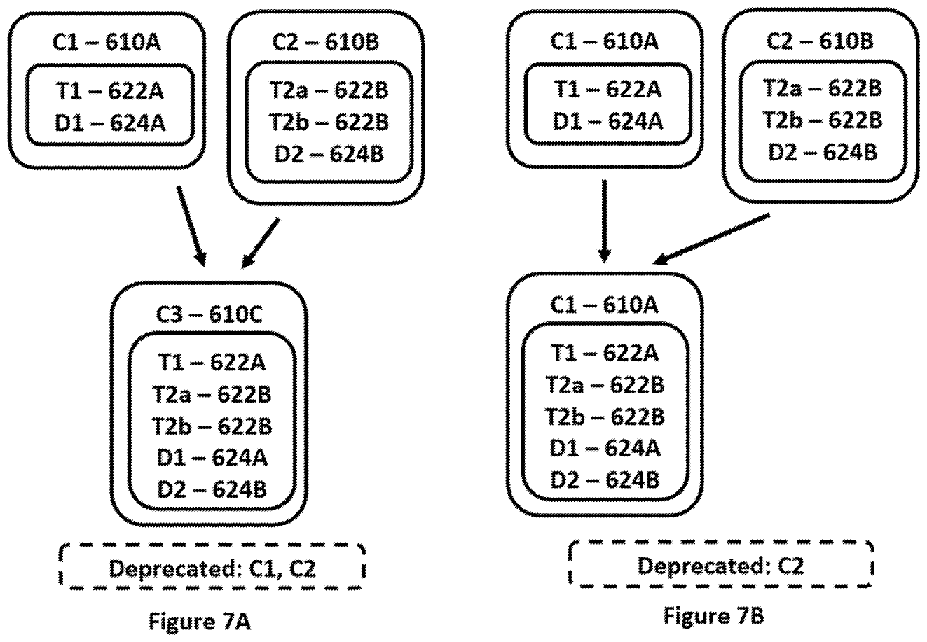

The merging (consolidation) of concepts 610 as described above is illustrated in FIGS. 7A and 7B, which are schematic diagrams depicting two different methods for curating concepts in a data dictionary. In FIG. 7A, the initial situation is that the data dictionary 140 includes concept C1 610A and concept C2 610B. Concept C1 includes term T1 622A and definition D1 624A, while concept C2 includes terms T2a 622B, T2b 622B and definition D2 624B. This initial situation might be typical of data stores 100 in which concepts are added to the data dictionary 140 whenever requested by a user, but without consideration of whether they overlap or are not distinct from concepts that already exist within the data dictionary 140.

For example, concept C1 may relate to a product (physical component) from a first distributor, while concept C2 may relate to a product (physical component) from a second distributor. In a conventional approach, concepts C1 and C2 both exist as separate, distinct entries in the data dictionary. A query to the data dictionary 140 relating to C1 is generally based on the term(s) and/or definition(s) of C1, which may be different from the term(s) and/or definition(s) of C2—hence such a query would not pick up anything relating to the concept C2.

However, in accordance with the approach described herein, the concepts C1 and C2 are held to be equivalent, and so they are merged into a single (new) concept C3 610C. The new concept C3 includes (inherits) the superset of terms and definitions from both concept C1 and concept C2. Thus new concept C3 has terms T1 (from concept 1) and T2a, T2b (from concept 2). Likewise, new concept C3 has definitions D1 from concept 1 and D2 from concept 2. The single new concept C3 is entered into the data dictionary 140 in place of C1 and C2. In the example of FIG. 7A, concepts C1 and C2 are retained in deprecated form in the data dictionary, such as for audit and legacy purposes.

In FIG. 7B, the initial situation is the same as described above for FIG. 7A, however, the procedure for merging the two concepts C1 and C2 is slightly different from the procedure shown in FIG. 7A. In the procedure of FIG. 7B, rather than creating a new concept C3 for the single output concept, the single output concept in FIG. 7B is formed by modifying existing concept C1. In particular, the terms and definitions from concept C2 are copied over into concept C1. Furthermore, the concept C2 is marked as deprecated (but unlike with FIG. 7A, C1 is not deprecated, because modified C1 represents the single active concept resulting from the merger of C1 and C2). It can be seen that the modified existing concept C1 of FIG. 7B contains the same set of terms T1, T2a, T2b and definitions D1, D2 as concept C3 in FIG. 7A—hence the end results in FIGS. 7A and 7B are effectively the same. Note that if there is an exact match between a term from C1 and a term from C2, or between a definition from C1 and a definition from C2, the repeated (duplicate) term or definition may be deleted from the single output concept (C3 or modified C1), so there is only a single entry in the concept for each distinct term or definition.

As illustrated in FIGS. 7A and 7B, the data store described herein is used to curate the concepts by merging concepts which are identified as equivalent to one another. Although FIGS. 7A and 7B show the merger of two concepts, in some cases more than two concepts may be merged together (generally following the same overall procedure as shown in FIG. 7A or 7B). In addition, it will be appreciated that there may be multiple iterations of concept merging. For example, at some future time, the concept C3 (or the modified concept C1) may be subject to further merging, e.g. because some new concepts have been entered into the data dictionary 140.

We now return to the situation described above, in which an operator has a physical component to be replaced, such as in a large engineering system. The replacement may be due to various reasons, such as a scheduled end of life replacement after a set level of usage, a detected degradation of the currently installed component, or a recent failure of the currently installed physical component. An operator of the system may seek to locate, in a supplier catalogue, a replacement for the physical component. The supplier catalogue may be integrated into the data store 100 as master data 110 as described above. The operator may search for the desired replacement such as by entering a term describing the physical component

In a pre-merged configuration, the user may locate a concept such as C1 based on a search performed for a term included in C1. This in turn may present to a user catalogue entries (corresponding to physical components) that incorporate or reference the concept C1. However, this search would generally not locate C2 (because the search term would not be included in C2). This separation (independence) between C1 and C2 may not cause a problem while a product incorporating concept C1 remains readily available from a distributor. However, at some stage the first distributor may be unable to provide a physical component corresponding to C1-e.g. because the product has been discontinued or is out of stock. A conventional data dictionary, such as shown in the initial (top, pre-merged) states of FIGS. 7A and 7B, provides relatively little assistance to the operator in such a situation.

In contrast, in the merged configuration as described herein, the single output concept (C3 or modified concept C1) may be located using a term from C1 or a term from C2, since the single output concept comprises a superset of terms from both C1 and C2. Furthermore, with knowledge of this single combined output concept, a user is able to locate master data records 210 for physical components that are described by (or otherwise associated with) this concept. Searching with the same term as before now locates the new single concept; since this new concept includes terms/concepts associated with both of the initial concepts C1 and C2, and this provides access to the physical components that reference this single output concept. Accordingly, if the operator is unable to find an available product replacement relating to original concept C1 from the first distributor, the merged (single) output concept allows the operator instead the possibility of finding an available replacement physical component relating to original concept C2 from the second distributor. In particular, this supply of information relating to C2 and associated physical components is directly provided to the operator as an adjunct to the supply of information relating to C1 and associated physical components, rather than requiring the user to make an additional search by hand.

Accordingly, the curation of the data dictionary 140 allows an operator to automatically locate more quickly alternative sets of physical components which may be used as a replacement for the large engineering system. This in turn may help to reduce downtime for the large engineering system, in that the replacement physical component is acquired more quickly, thereby enhancing the overall efficiency of the large engineering system.

A further potential benefit relates to a rationalisation of stock (parts) control for a large engineering system. For example, if a first concept is associated with a first physical component (PC1) in a large engineering system, and a second concept is associated with a second physical component (PC2), an operator of the large engineering system may maintain stock of both PC1 and PC2 to minimise downtime in the event of a failure of an installed PC1 or PC2. However, the curation of the data dictionary may expose the equivalence of the first and second concepts, which may in turn indicate that PC2 would be a suitable replacement for PC1 (and vice versa). With this understanding, the operator may decide to stock just PC2, but not PC1, whereby PC2 would be used to replace any failed PC1. This rationalisation generally reduces the total number of physical components that need to be maintained, which leads to more efficient (and cheaper) stock control.

It is noted that determining an equivalence between two class concepts, such as C1 610A and C2 610B in FIGS. 7A and 7B, does not imply an exact identity between a first physical component corresponding to concept C1 and a second physical component corresponding to concept C2 610B. Rather, the first and second physical components may differ from one another in a way which is not considered in the curation process, for example, regarding details of plastics materials used for the first and second physical component. Accordingly, in all cases, when a master data record 210 (corresponding to a catalogue entry) has been identified as providing a possible implementation of a given physical component for inclusion in a large engineering system, the full specification of the physical component, such as might be provided via a data sheet, should be accessed and reviewed to confirm that this physical component is fully compatible with use in the large engineering system.

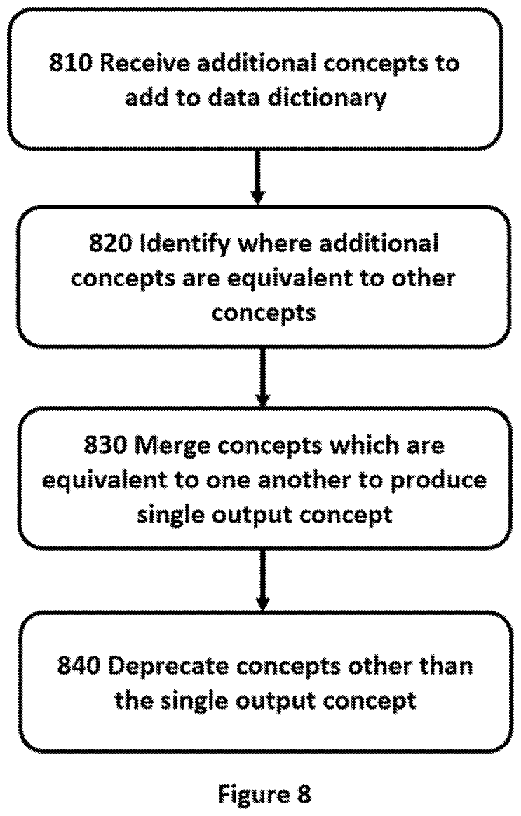

FIG. 8 is a flowchart illustrating an example of the curation of the data dictionary as described above. In a first operation 810, the data store 100 receives one or more concepts to be added to a data dictionary 140. These new concepts may arise for example because a new standard has issued, or a distributor has published a new product catalogue. Note the curation of the data dictionary 140 may also be performed on existing concepts in the data dictionary (rather than just newly added concepts), for example as part of a data cleansing operation.

In a second operation 820, the new concepts are reviewed to see if any of the new concepts are equivalent to concepts already in the data dictionary (or equivalent to other ones of the new concepts). Again, such a review may also be performed as part of a cleansing operation for existing concepts in the data dictionary, without necessarily having any new concepts.

This review may be performed by a human with skilled knowledge of the relevant technical field. An alternative approach may exploit artificial intelligence (AI) and/or machine learning (ML) systems (or similar) to perform this review. One approach is to have a review performed by an Al system, and the results of this review are subject to subsequent confirmation by a human operator. Further information about an Al implementation using a large language model (LLM) is described in more detail below.

If any concepts are found to be equivalent to one another, the equivalent concepts in the data dictionary 140 are merged at operation 830 into a single concept such as illustrated in FIGS. 7A, 7B as discussed above. From one perspective, this can be considered as adding aspects of a thesaurus to the data dictionary 140, in that the merging collects together similar items that all share the same meaning and so fall within a particular grouping or class concept. As a corollary of this merger, concepts identified for merging because they are equivalent to one another, but which did not form the basis for the single output (merged) concept, may have their status set to deprecated at operation 840, so they are no longer involved in normal user operations with the data store 100 but may remain accessible such as for use by legacy products that reference the original concept.

FIG. 6 as discussed above illustrates a particular type of concept, name a class concept, but the data dictionary 140 in data store 100 supports a number of concept types, such as listed below (by way of example only and without limitation):
class—abstraction of a set of similar objects-e.g. similar physical components
property—quality or feature of a product
value of a property (value domain)—instance of a specific value together with an identifier for a data dictionary entry that defines a property
unit of measurement—real scalar quantity, defined and adopted by convention, with which any other quantity of the same kind can be compared to express the ratio of the second quantity to the first one as a number
qualifier of measurement—indication of a value not being an actual, exact, representation of a single instance of measurement. Example: qualifiers can include “nominal”, “maximum”, “minimum” and “typical”
representation—specification of the pattern that members of a set of data must adhere to, including data type, constraints, combinations and logical expressions.

Some of these additional types of concept have already been introduced as part of the property-value pairs used in a master data record 210 (see FIGS. 2 and 3) and a data specification record 410 (see FIG. 4). For example, FIG. 2 shows master data record 210 for a catalogue item SKF: 002 212, and this master data record includes a Property column and a Value column that in combination list a set of property-value pairs. Each of these property and value pairs includes items in a predetermined colour, such as blue (not distinguished in FIG. 2) which is indicative of a concept. For example, “bore type” in FIG. 2 is a property concept, while “cylindrical” is a value concept. The property and value concepts are paired together, and the value concept of cylindrical is one of the possible values associated with the property bore type (and is the specific value of this property for the catalogue item SKF: 002 212).

With reference to FIG. 4 showing a data specification record 410, again there is a set of property-value pairs set out in a Property column and a corresponding Value column. Each of these columns includes items in a particular colour (e.g. blue) which is indicative of a concept. For example, “filling slot” is a property concept, and a set of two values are specified, namely “with” and “without”. These two values can be considered as representing a drop-down list of two possible values that can be paired with the property for catalogue items associated with this data specification record 410. In the example of FIG. 2, the illustrated master data record 210 has a value of “without” for the property of “filling slot”.

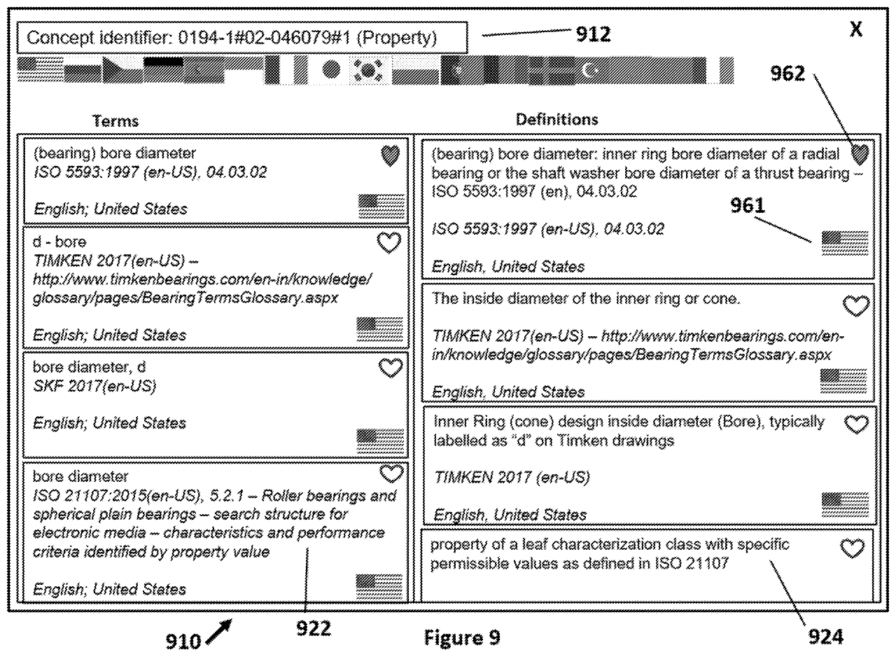

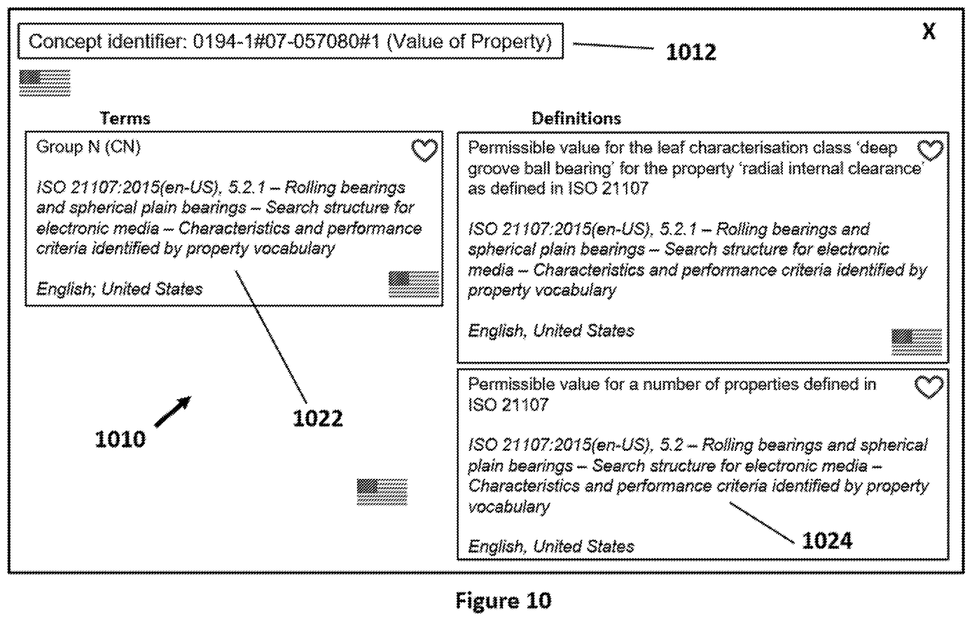

FIGS. 9 and 10 are schematic representations of other examples of a concept in a data dictionary which may be used in a data store such as shown in FIG. 1. In particular, whereas FIG. 6 shows a class type concept, FIG. 9 shows a property type concept 910 and FIG. 10 shows a value type concept 1010. The general format of a concept is the same across all types of concept, and with reference to FIGS. 9 and 10 includes a concept identifier 912, 1012, one or more terms 922, 1022, and one or more definitions 924, 1024.

The concepts shown in FIGS. 6, 9 and 10 include two small icons for each term and for each definition. An example of these two icons is identified in FIG. 9. The first icon 961 is a language identifier and shows the language in which the corresponding information (term or definition) is to be displayed (out of the set of available languages shown just below the concept identifier 912). The second item 962 has the form of a heart. A solid heart represents a user-selected preference (if set). Thus with reference to FIG. 9, the preferred term is “(bearing) bore diameter” and the preferred definition is the first one, namely “(bearing) bore diameter: inner ring bore diameter of a radial bearing or the shaft washer bore diameter of a thrust bearing . . . ”. The user preference of this term and definition becomes the default display representation for this concept during use of the data store 100.

The property and value concepts 910, 1010 may be curated and merged if so desired, in a similar manner to the class concepts 610 as described above. In addition to the class, property and value types of concept, there are also concepts representing a unit of measurement, a qualifier of a measurement, and a representation. The format and usage of these further types of concept generally follow the format and usage of the class, property and value types, and hence will not be discussed further.

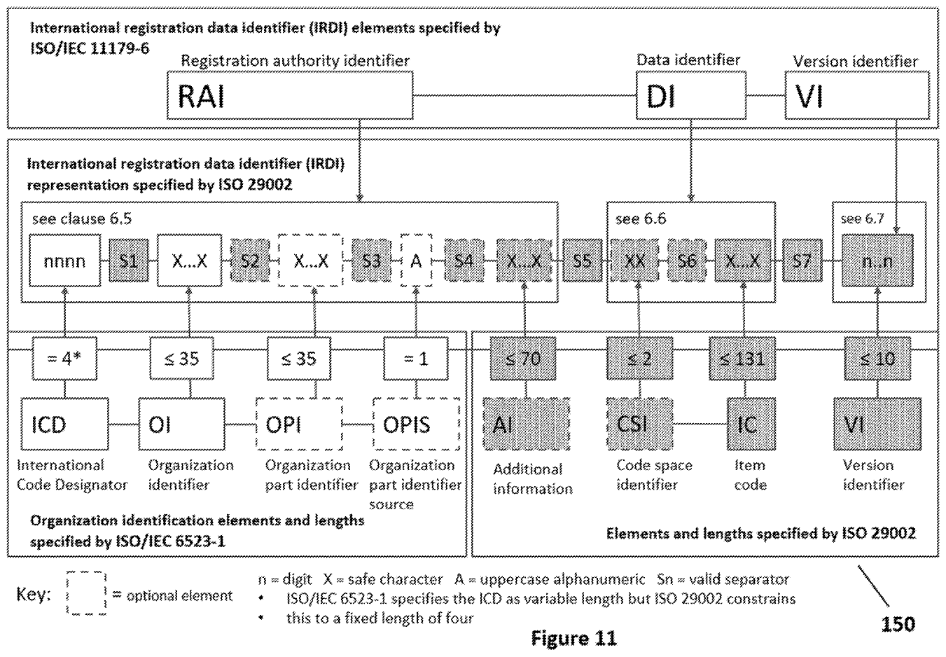

FIG. 11 is a schematic, example representation of the construction of identifiers in accordance with an identification scheme 150 provided by a data store 100 such as shown in FIG. 1. This identification scheme 150 will be described only briefly, since further details can be accessed by the relevant ISO standards already cited FIG. 11. One example of a concept identifier 612 is 0194-1 #01-003368 #1 as shown in FIG. 6; another example of a concept identifier 912 is 0194-1 #02-046079 #1 as shown in FIG. 9.

The business KOIOS Master Data is registered in the ISO/IEC 6523-1 scheme, and has been allocated the International Code Designator: 0194. Both of the above concept identifiers 612, 912 commence with 0194 which in effect provides an indication of (registered) origin for the concepts having these concept identifiers. The main other component in the identifier 612, 912 is the item code. In other words, each concept created or adopted by KOIOS Master Data under International Code Designator=0194 is generally assigned an item code comprising a character sequence which is unique within the 0194 domain.

In some implementations, the item codes are sparsely distributed across the set of possible item codes. For example, in the above examples 612, 912, the item code comprises 6 digits, so that there are N=1 million possible item codes. If we actually have (say) n=5000 concepts with item codes to apply, then n<<N. Moreover, the 5000 concepts are not simply allocated to item codes 1-5000, but rather distributed widely (and sparsely) across the full range of possible codes up to 999999. Such a distribution could be achieved by using a random number generator or encryption scheme to determine an item code within the full range.

The motivation for using such a sparse distribution across the full range of item code values is to recognise the value in the set of curated concepts that are developed as described herein. Such concepts may be held in data store 100. If the allocated item codes for these concepts follow a simple pattern (such as the concepts populating items codes 1-5000) it would be relatively easy for a third party to predict all the used item codes and to access and copy the relevant concept for each item code in turn. However, by using the sparse distribution across the space of possible item codes, a third party would in effect have to access the full space of possible item codes to locate and copy the set of item codes which have actually been populated. This would be a much more onerous task, and hence the sparse distribution helps to protect ownership of the curated concepts.

FIG. 12 is a schematic diagram of an example computer screen for utilising a data store 100 such as shown in FIG. 1. Typically this computer screen is provided as part of the front end (user interface) of a software application configured to utilise the data store 100 of FIG. 1. The left-hand portion (bar) of the screen 225 has already been discussed above with reference to FIG. 2. The right-hand portion shows the result of a search performed on the master data records 210 (only some of the search results are shown in FIG. 12, the rest can be located by scrolling through the search results in a conventional fashion). Each search result 1121 in FIG. 12 corresponds to a catalogue entry which satisfies the initial search string “SKF”; and each of the displayed search results has a different numerical suffix.

Note that some of these search results 1121 may involve curated concepts. For example, a first catalogue entry may incorporate or reference a first concept, and a second catalogue entry may incorporate or reference a second concept. In this situation, a search using the first concept may locate the first catalogue entry but not the second catalogue entry, whereas conversely a search using the second concept may locate the second catalogue entry but not the first catalogue entry. However, if the first and second concepts are merged (curated) to produce a new third concept (see FIG. 7A), then a search for this third concept would locate both the first and second catalogue entries. Such a search might be instigated by changing the search query specified in the input field near the top of the screen shown in FIG. 12.

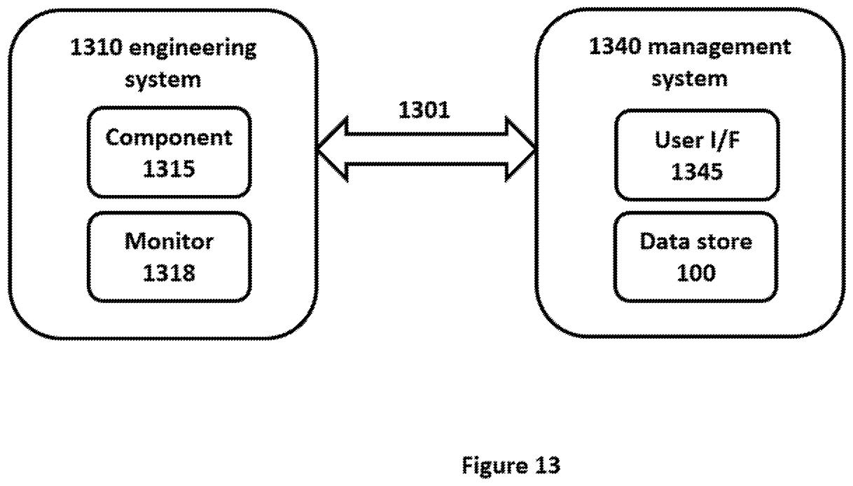

FIG. 13 is a schematic diagram of an engineering system 1310 interacting with a typically separate management system 1340 which uses a data store 100 such as shown in FIG. 1. The engineering system 1310 and the management system 1340 are connected by a data communications link 1301 which may provide local or remote communications according to the configuration of any given implementation. The engineering system 1310 may be a complex and/or large engineering system having many physical components-such as component 1315. The components may for example be mechanical, electrical, electro-mechanical, or electronic.

The management system 1340 may be implemented on a conventional computing platform having one or more processors to run (execute) programs using data, such as from data store 100, held in some form of memory/storage used by the management system 1340. The management system 1340 further includes a user interface (IF) 1345 to allow a user to control the management system 1340.

As shown in FIG. 13, the engineering system 1310 may include a monitor 1318 which receives input from various sensors concerning the operation of the engineering system 1310. The monitoring information acquired by the monitor 1318 may be communicated back to the management system 1340. The monitor 1318 and/or the management system 1340 may detect an issue with the component 1315. This may indicate that the component is approaching the end of its expected lifetime and so should be replaced—e.g. based on the timing since the component 1315 was installed, or on some other operational measure of overall activity (such as number of total outputs if the engineering system 1310 is part of a manufacturing line). The monitor may also sense some degradation in the performance of the component 1315, for example, it may be generating excess heat, or cutting with an accuracy that only just satisfies applicable tolerances. In other cases, the component 1315 may have failed completely. The monitor 1318 may report over the communications link 1301 to the management system 1340 the failure (or imminent/expected failure) of component 1315, or this may be determined by the management system based on information received from the monitor 1318. The monitoring and the reporting to the management system 1340 may be performed with human oversight or may be performed on an automatic basis (without human involvement).

In response to the determination about the component 1315, the management system 1340 utilises the data store to retrieve information about a suitable replacement for component 1315. This retrieval may involve accessing one or more concepts that have been the subject of curation as described herein. Depending upon the circumstances, this curation may lead to the direct identification of a type of component to act as replacement for physical component 1315, where such direct identification would not have been made if the curation had not been performed.

This identification of a component to act as a replacement in response to the monitoring information may in some systems be performed automatically, including access to the data store 100. In other systems, the identification may include human involvement such as via user interface 1345 to interact with the data store 100. In some cases, the management system 1340 may automatically identify a replacement component using the data store, and notify this to a human operator for confirmation. The management system 1340 may also access other information about the replacement component, such as current stock level (if any), supplier identity, and so on. In some cases, the management system 1340 may provide information on multiple possible replacement components, and the user selects a particular replacement to be used.

Having identified and confirmed a replacement component, the replacement of component 1315 is now implemented. This may involve firstly ordering or otherwise acquiring the relevant component. When such a component is available, the replacement can be completed. In most situations, the replacement may be installed by a human engineer. However, in some cases the replacement may be performed automatically in the engineering system, for example based on a hardware and/or software reconfiguration.

As described herein, the curated data dictionary 140 can support a quicker identification of a replacement for component 1315 (especially if a direct replacement from the same manufacturer is no longer readily available). This quicker identification then allows for a quicker replacement of component 1315, which in turn may enhance the overall operation of the engineering system 1310 for example, it might allow the component 1315 to be replaced before this component suffers a complete breakdown (or to be replaced more quickly after such a breakdown has occurred). In both cases, disruption to the operation of the engineering system 1310 may therefore be reduced compared to existing systems which do not perform curation of the data dictionary as described herein.

Furthermore, as discussed above, a local stock of replacement parts may be maintained for engineering system 1310. Prior to curation, this local stock may maintain separate inventory for the two different physical components. However, following curation, it may become apparent that these two different components are equivalent, so that the local stock only has to maintain inventory for one of the physical components, which can then be used as a replacement for either of the two physical components.

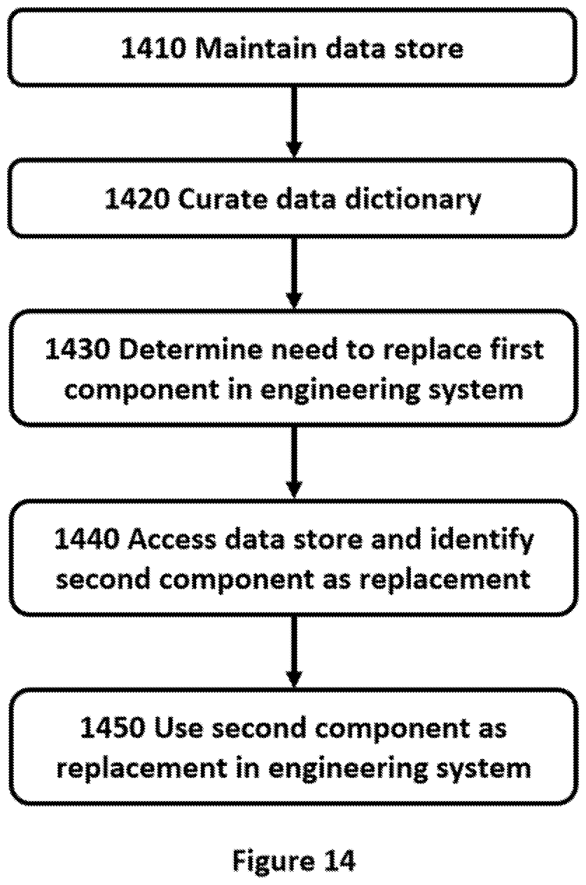

FIG. 14 is a flowchart showing an example of a method for operating an engineering system. The method commences at operation 1410 with maintaining a data store 100 such as illustrated in FIG. 1. It will be appreciated that maintaining the data store is generally an ongoing activity, which may be continued through all the operations shown in FIG. 14.

At operation 1420, a data dictionary 140 which is part of the data store 100 is curated. Such curation may comprise merging two concepts into a single concept within the data dictionary when the two concepts are regarded as generally equivalent to one another. This curation not only simplifies the data dictionary 140, but also enhances connectivity within the data dictionary 140. For example, a first concept may incorporate a first set of terms and definitions, while a second concept may incorporate a second set of terms and definitions. A third concept formed by merging the first and second concepts may be accessed by both the first set of terms and definitions and also by the second set of terms and definitions. Again, it will be appreciated that curating the data dictionary may be performed as an ongoing activity.

At operation 1430, a determination is made that a first physical component within an engineering system such as discussed above has to be replaced. There are various reasons why such a replacement may be required—for example, because the first physical component has failed (partly or completely), because the first physical component is approaching the end of its operational lifetime, because the engineering system is being upgraded and this implies the first physical component should be replaced, and so on.

At operation 1440, the data store maintained in operation 1410 is accessed to identify a second physical component which is a suitable replacement for the first physical component (such access may be performing automatically or manually). In some cases, the curation of the data dictionary 140 at operation 1420 may support this identification of the second physical component. For example, the first and second physical components may incorporate first and second concepts respectively. If the first and second concepts are merged as part of the curation procedure, then the merged concept provides a link between the first and second physical components, which may be used to identify the latter as a potential equivalent of (and replacement for) the former.

At operation 1450, the second component is used to replace the first component in the (large) engineering system. In some cases, using the second physical component as the replacement (rather than another first physical component) may facilitate the replacement, for example if the second physical component has a reduced delivery time. This then helps to mitigate the failure of the first physical component by allowing the engineering system to be restored more quickly to a fully operational state.

The above description has primarily considered the use of a curated data dictionary 140 to help manage physical components in a large engineering system. For example, this may involve prompt and appropriate replacement of physical components so as to reduce downtime of the engineering system (compared to the downtime that would be experienced using a data dictionary that had not been curated). Such curation may also lead to more efficient maintenance of spare parts. However, there are other contexts in which the curated data dictionary 140 relating to physical components may be used.

In some cases, the system described herein may be confronted with a new term which it has not previously encountered. In such a situation, the system may try to ascertain the most semantically akin existing concept. One way of adopting such an approach is based on Retrieval Augmented Generation (RAG), which is a tool used in artificial intelligence (Al) systems. For more information on RAG, see, by way of example: https://learn.microsoft.com/en-us/azure/search/retrieval-augmented-generation-overview.

The RAG technology is use to form a hybridization of (i) a data store (including a curated data dictionary as described herein), referred to here as a knowledge hub, and (ii) a Large Language Model (LLM). The LLM provides natural language processing—see (for example) https://en.wikipedia.org/wiki/Large_language_model.

To utilise such an LLM, the knowledge hub is structured and vectorized, and typically resides within a vector index in cloud infrastructure. The foundational technology underpinning the LLM is a transformer, a deep learning architecture, pre-trained on an extensive corpus of textual data. This pre-training enables the model to discern patterns in token occurrences, with tokens serving as discrete linguistic units (akin to words for simplicity in this context). Subsequently, the model utilizes these patterns to predict the next most probable token following an input token. For instance, after “deep groove,” there might exist a 95% likelihood of “bearing” being the subsequent token. Note however that individual words lack inherent meaning in isolation, and may be prone to misinterpretation or misunderstanding without contextual information.

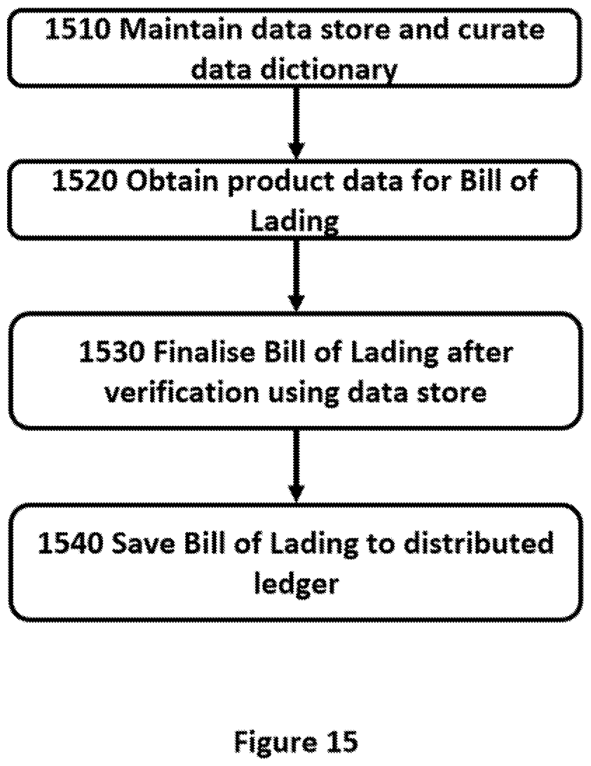

The knowledge hub described herein uses the concept dictionary to amalgamate equivalent terms (tokens) with their respective definitions (context). Vector embeddings provide a mechanism to convert words or sentences into numerical tokens, stored as mathematical vectors. Upon conversion to vectors, mathematical calculations facilitate the determination of the distance between two vectors, yielding a similarity score between two terms. Consequently, upon receiving a new term, vectorization ensues, enabling rapid retrieval of the most analogous concepts based on vector distance. The retrieved terms and their accompanying definitions are furnished to a Large Language Model for discerning the semantically closest concept to the input term. Subsequently, validation of the accuracy of the match ensues. With each correct match, the model undergoes further refinement. FIG. 15 is a flowchart showing a computer-implemented method for supporting authentication of product transportation using a data store such as shown in FIG. 1. In particular, in order for products to be used, physical components (parts or complete devices) are transported from a manufacturer to a end user. This transportation may be direct, or may include one or more intermediaries, such as an exporter, importer, distributor, and so on. The transportation of such physical components is frequently managed by a Bill of Lading or similar document or transportation record, usually now created in electronic form.

Operation 1510 in FIG. 15 involves maintaining a data store 100 as described above, including curating a data dictionary 140. As described above, such curation of the data dictionary 140 may involve the merger of equivalent class concepts, but the curation may also encompass further actions. For example, the curation may be used to ensure that the terms and definitions provided for concepts are associated with appropriate source information. Such source information is included in the example concept shown in FIG. 6, in which the first term “deep groove ball bearing” is referenced to a particular location in ISO 5593:2019. Furthermore, in the data specification shown in FIG. 4, the value domain is generally constructed as a finite list (e.g. a dropdown list), rather than having open-ended domains for the values. The use of finite, specified domains enhances consistency across the data dictionary 140 and this in turn helps to ensure reliability. In some cases the quality of the stored data may be scored. For example, data that is supported by an ISO definition is scored with a higher quality than data which is support only by a manufacturer.

In operation 1520, information relating to one or more products (e.g. parts or devices) that are being prepared for transportation (shipping) is extracted from the data store. This product information is generally received by a carrier (the party arranging the shipment) and may be received from a client who has requested the shipment.

In operation 1530, the Bill of Lading (transportation record) may be finalised by the carrier using the product data from the client. The carrier may perform one or more verifications of the product data received from the client against data held in the data store 100. For example, a verification may be performed with respect to data such as part number, manufacturer, product size, hazardous materials, and so on. In this context, the data store 100 (and especially the curated portions) are regarded as providing reliable information for performing these verifications. Assuming that the verifications are successful, the Bill of Lading can be finalised. In some cases, the finalised Bill of Lading may include other relevant information (not necessarily from the data store), for example geo-location data such as from GPS or other similar systems.

In operation 1540, the verified Bill of Lading (or other similar document containing relevant information about the shipment) may then be saved to a distributed ledger (DL). A DL is generally implemented in the form of a blockchain which is maintained in man copies spread across a community (rather than say by a single trusted party). Each new transaction (such as a Bill of Lading) is saved by different members of the community. Although different members may initially differ in the order in which they receive transactions, the block chain has a mechanism to select a single, unique ordering, which is then provided to (and implemented by) all members of the community. This allows the DL to provide a reliable and definitive set of information representing (at least) the Bill of Lading which is available to relevant parties as a formal record of the transaction and shipment.

In conclusion, the present disclosure provides, inter alia, a method and apparatus for providing and using a data dictionary implemented on a computer system. The computer system described herein may be implemented using a combination of hardware and software. The hardware (machine) may comprise a standard, general-purpose computing device, or in some implementations, the hardware may include more specialised components, such as a graphical processing units (GPUS). The software generally comprises one or more computer programs to run on the hardware. These computer programs comprise program instructions which are typically loaded into memory of the computing system for execution by one or more processors to cause the computing system to implement the above method. The computer program may be stored in a non-transitory medium prior to loading into memory, for example, on flash memory, a hard disk drive, etc. The operations of the computer system may be performed sequentially and/or in parallel as appropriate for any given implementation.

Various implementations and examples have been disclosed herein. It will be appreciated that these implementations and examples are not intended to be exhaustive, and the skilled person will be aware of potential variations and modifications of these implementations and examples that fall within the scope of the present disclosure. Certain implementations may comprise any appropriate combination of the features disclosed herein without limitation to the particular combinations provided by the claims. It will also be understood that features of particular implementations and examples can typically be incorporated into other implementations and examples (unless the context clearly indicates to the contrary). In summary, the various implementations and examples herein are disclosed by way of illustration rather than by way of limitation and the scope of the present case should be determined from the appended claims and their equivalents.

1. A method of constructing and/or operating an apparatus comprising multiple different physical components said method including steps of:
maintaining a computer-implemented data store, the data store comprising at least master data and a data dictionary, wherein the data dictionary defines a set of concepts, and wherein the master data comprises a set of records, each record corresponding to a type of physical component and being associated with a concept in the data dictionary that describes the type of physical component;
curating the data dictionary by identifying first and second concepts in the data dictionary which are equivalent and which describe first and second types of physical component, and combining the first and second concepts into a single concept in the data dictionary to describe both the first and second types of physical component;
determining that a physical component having a first type is to be utilised for a task which forms part of constructing and/or operating the apparatus;
accessing the data store and identifying a physical component of the second type, wherein the first and second types of physical components are both described by said single concept; and
using a physical component of the second type of physical component for constructing and/or operating the apparatus.

2. The method of claim 1, wherein the records of the master data comprise a bill of materials for constructing the apparatus.

3. The method of claim 1, wherein the records of master data comprise a catalogue of physical components available from a supplier.

4. The method of claim 1, wherein the first and second concepts are combined into a single new concept which is created to represent the combined first and second concepts.

5. The method of claim 4, further comprising maintaining the first and second concepts in the data store in a deprecated form.

6. The method of claim 1, wherein a concept describing a type of physical component comprises at least one term and at least one definition.

7. The method of claim 6, wherein the single concept comprises the at least one term and at least one definition from the first concept and the at least one term and the at least one definition from the second concept.

8. The method of claim 1, wherein the computer-implemented data store further comprises a set of data specification records, wherein each data specification record defines a corresponding class of physical components.

9. The method of claim 8, wherein each entry for a type of physical component in the master data conforms to the data specification record for the class which encompasses that type of physical component.

10. The method of claim 8, wherein each data specification record is specified using concepts from the curated data dictionary.

11. The method of claim 8, wherein the data store further comprises a data syntax for representing the master data records and/or data specification records.

12. The method of claim 8, wherein the data store further comprises an identification scheme for generating identifiers for the data specification records.

13. The method of claim 12, wherein the identifiers are allocated from a defined range of values such that the allocated identifiers are distributed sparsely across the defined range.

14. The method of claim 1, further comprising identifying with an artificial intelligence system the first and second concepts in the data dictionary are equivalent.

15. The method of claim 14, wherein the artificial intelligence system is based on Retrieval Automated Generation technology and/or a large language model.

16. The method of claim 1, wherein using a physical component of the second type of physical component for operating the apparatus includes using the physical component of the second type as a spare part for a physical component of the first type.

17. A computer-implemented system for constructing and/or operating an engineering apparatus comprising multiple different physical components, said system including a computer-implemented data store, the data store comprising at least master data and a data dictionary, wherein the data dictionary defines a set of concepts, and wherein the master data comprises a set of records, each record corresponding to a type of physical component and being associated with a concept in the data dictionary that describes the type of physical component; wherein the system is configured to:
curate the data dictionary by identifying as equivalent first and second concepts in the data dictionary that describe first and second types of physical component, and combining the first and second concepts into a single concept in the data dictionary to describe both the first and second types of physical component;
determine that a physical component of the first type is to be utilised for a task which forms part of constructing and/or operating the apparatus;
access the data store and identify a physical component of the second type, wherein the first and second types of physical components are both described by said single concept; and
use a physical component of the second type for constructing and/or operating the apparatus.

18. The system of claim 17, wherein the system is configured to:
receive monitoring information from the engineering apparatus;
and to determine from the monitoring information that a physical component of the first type is in need of replacement;
wherein the physical component of the second type is used for said replacement.

19-23. (canceled)
